(19) United States
(12) Patent Application Publication
(10) Pub. No.: US 2026/0095967 A1
(43) Pub. Date: Apr. 2, 2026

(54) SYSTEMS AND METHODS FOR DYNAMICALLY PRUNING RADIO ACCESS TECHNOLOGIES (RATS) IN WIRELESS COMMUNICATION NETWORKS

(71) Applicant: Apple Inc., Cupertino, CA (US)

(72) Inventors: Ioannis Pefkianakis, San Jose, CA (US); Muthukumaran Dhanapal, San Diego, CA (US); Neeraj D. Vaghela, San Jose, CA (US); Prashant H. Vashi, San Jose, CA (US); Raghuram Mungara, Sunnyvale, CA (US); Sharad Garg, Cupertino, CA (US); Vijay Gadde, San Jose, CA (US)

(21) Appl. No.: 19/110,731

(22) PCT Filed: Sep. 8, 2023
(86) PCT No.: PCT/US2023/032285

§ 371 Date: Mar. 11, 2025

Related U.S. Application Data
(60) Provisional application No. 63/406,049, filed on Sep. 13, 2022.

(51) Int. Cl. H04W 76/15

(52) U.S. Cl. CPC H04W 76/15

(57) ABSTRACT

Disclosed are methods, systems, and computer-readable medium to perform operations including obtaining data representing: one or more characteristics of a first wireless link between the UE device and a wireless network, and one or more characteristics of a second wireless link between the CE device and the wireless network; determining, based on the data; a first estimated data throughput between the UE device and the wireless network using the first wireless link and the second wireless link concurrently, and a second estimated data throughput between the UE device and the wireless network using the first wireless link and without using the second wireless link; determining, based on the first estimated data throughput and the second estimated data throughput, whether a first set of criteria is satisfied; and upon determining that the first set of criteria is satisfied, terminating the second wireless link.

### PRIORITY CLAIM

The present application claims priority to U.S. Provisional Patent Application No. 63/406,049, filed on Sep. 13, 2022, entitled “SYSTEMS AND METHODS FOR DYNAMICALLY PRUNING RADIO ACCESS TECHNOLOGIES (RATS) IN WIRELESS COMMUNICATION NETWORKS,” which is herein incorporated by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method performed by a user equipment (UE) device includes: obtaining data representing: one or more characteristics of a first wireless link between the UE device and a wireless network, and one or more characteristics of a second wireless link between the UE device and the wireless network; determining, based on the data: a first estimated data throughput between the UE device and the wireless network using the first wireless link and the second wireless link concurrently, and a second estimated data throughput between the UE device and the wireless network using the first wireless link and without using the second wireless link; determining, based on the first estimated data throughput and the second estimated data throughput, whether a first set of criteria is satisfied; and upon determining that the first set of criteria is satisfied, terminating the second wireless link.

Implementations of this aspect can include one or more of the following features.

In some implementations, the one or more characteristics of the first wireless link can include a signal strength of the first wireless link, and the one or more characteristics of the second wireless link can include a signal strength of the second wireless link.

In some implementations, the first estimated data throughput and the second estimated data throughput can be determined based on the signal strength of the first wireless link and the signal strength of the second wireless link.

In some implementations, the first estimated data throughput and the second estimated data throughput can be determined based on historical data obtained from one or more additional UE devices.

In some implementations, the first set of criteria can include a criterion that the second estimated data throughput is greater than a sum of the first estimated data throughput and a constant value.

In some implementations, the constant value can be zero.

In some implementations, the constant value can be greater than zero.

In some implementations, the first set of criteria can further include a criterion that a first metric representing an upload activity of the UE device is greater than a first threshold value.

In some implementations, the first metric can be calculated based on an uplink duty cycle of the UE device.

In some implementations, the first set of criteria can further include a criterion that a second metric representing a download activity of the UE device is less than a second threshold value.

In some implementations, the second metric can be calculated based on a downlink duty cycle of the UE device.

In some implementations, the first wireless link can be established using a first radio access technology (RAT), and the second wireless link can be established using a second RAT different from the first RAT.

In some implementations, the first RAT can be a stand-alone RAT, and the second RAT can be a non-stand-alone RAT.

In some implementations, the first RAT can be a Fourth Generation (4G) RAT, and the second RAT can be a Fifth Generation Non-Stand-Alone (5G-NSA) RAT.

In some implementations, the method can further include, subsequent to terminating the second wireless link: re-determining, based on the data: the first estimated data throughput, and

the second estimated data throughput; determining, based on first estimated data throughput and the second estimated data throughput, whether a second set of criteria is satisfied; and upon determining that the second set of criteria is satisfied, re-establishing the second wireless link.

In some implementations, the second set of criteria can include a criterion that the first estimated data throughput is greater than a sum of the second estimated data throughput and the constant value.

In some implementations, the second set of criteria can include a criterion that a time at which the second wireless link was terminated is earlier than a threshold time.

In another aspect, an apparatus includes one or more baseband processors configured to perform any of the method(s) described herein.

In another aspect, a system includes one or processors and one or more storage devices on which are stored instructions that are operable, when executed by the one or more processors, to cause the one or more processors to perform any of the method(s) described herein.

In another aspect, a non-transitory computer storage medium is encoded with instructions that, when executed by one or more processors, cause the one or more processors to perform any of the method(s) described herein.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates example radio access technology (RAT) pruning circuitry.

FIG. 3 illustrates an example process for dynamically pruning RATs.

FIG. 4 illustrates an example chart for estimating throughput based on the signal strength of a wireless link.

FIG. 5 illustrates a flowchart of an example method, according to some implementations.

FIG. 6 illustrates a user equipment (UE), according to some implementations.

FIG. 7 illustrates an access node, according to some implementations.

### DETAILED DESCRIPTION

In general, electronic devices can communicate with one another via a wireless network. As an example, a first electronic device can establish one or more wireless links with a second electronic device (e.g., using one or more wireless radios, transmitters, receivers, transceivers, etc.). Further, the first electronic device can transmit data to and/or receive data from the second device using the one or more wireless links.

In some implementations, a user equipment (UE) device can establish one or more wireless links with a base station of a wireless network, and communicate with one or more other devices (e.g., other UE devices, base stations, etc.) using the base station as an intermediary. For example, a UE device can establish one or more wireless links with a base station, and transmit data to the base station via the one or more wireless links. In turn, the base station can retain the data and/or transmit the data to one or more other devices (e.g., via one or more additional wired and/or wireless links). Further, the UE can receive data from the base station (e.g., data generated by the base station and/or devices communicatively coupled to the base station) via the one or more wireless links.

Further, a UE device can establish wireless links using one or more Radio Access Technologies (RATs). In general, RATs refer to the underlying physical connection method for a wireless network. Example RATs for a cellular network include those defined by technical standards developed by the European Telecommunications Standards Institute (ETSI) and the 3rd Generation Partnership Project (3GPP), such as Global System for Mobile Communications (GSM), Universal Mobile Telecommunications Service (UMTS), Long-Term Evolution (LTE), and 5G New Radio (5G NR).

In some implementations, a UE device can establish wireless links using multiple RATs concurrently. As an example, a UE can concurrently establish a first wireless link with a first base station using a first RAT and a second wireless link with a second base station using a second RAT. Further, the UE can exchange data with the first and second be stations concurrently using the first and second wireless links. This can be beneficial, for example, in enabling the UE device to exchange data more quickly and/or reliably in at least some circumstances. For example, in some circumstances, a UE device can transmit and/or receive data more quickly using multiple RATs concurrently (e.g., by combining the bandwidth or throughput of the wireless links established by those RATs) than using a single RAT alone. As another example, in some circumstances, a UE device can transmit and/or receive data more reliability or resiliently using multiple RATs concurrently than using a single RAT alone.

However, in some circumstances, it may be more beneficial for a UE device to establish a wireless link using a single RAT at a time. For example, a UE device may have limited resources (e.g., limited power resources, computational resources, etc.) that can be deployed to transmit and/or receive data. Due at least in part of these limitations, in some circumstances, the network performance of a UE device may be improved by establishing a wireless link with a base station using a single RAT at a time, rather than using multiple RATs concurrently.

As an example, a UE may include multiple antennas, each of which is used for transmitting or receiving data using a different respective RAT. Further, the UE device may have a limited transmission power budget (e.g., in accordance with technical and/or regulatory considerations) that can be shared across the antennas. In some circumstances, the UE device may transmit and/or receive data with a base station more quickly, efficiently, and/or reliably by establishing a wireless link using a single RAT (e.g., using a single respective antenna), rather than using multiple RATs concurrently (e.g., using multiple respective antennas). This may be the case, for example, when the UE device is far from the base station.

To improve the performance of the UE device, the UE device can dynamically adjust the number and/or types of RATs that are used to establish wireless links with base stations.

For instance, the UE device can use multiple RATs concurrently to establish multiple respective wireless links with one or more base stations. Further, the UE can dynamically terminate usage of one or more of the RATs (and correspondingly, the wireless links associated with the terminated RAT(s)) upon determining that doing so would improve the network performance of the UE device. This may be referred to as “pruning” one or more of the RATs.

As an example, the UE device can use two RATs to establish two concurrent wireless links with one or more base stations, and use the wireless link concurrently to transmit and/or receive data. Upon determining that it would be more beneficial to use a single RAT instead, the UE can dynamically terminate usage of one of the RATs (e.g., “prune” one of the RATs), such that a single wireless link is maintained using a single RAT, and transmit and/or receive data using that remaining wireless link. Further, upon determining that it would be beneficial to use the two RATs concurrently, the UE device can dynamically re-establish the previously terminated wireless link using the previously pruned RAT, and transmit and/or receive data using two wireless links concurrently.

Example system and techniques for dynamically adjusting the number and/or type of RATs used by a UE device are described in further detail below.

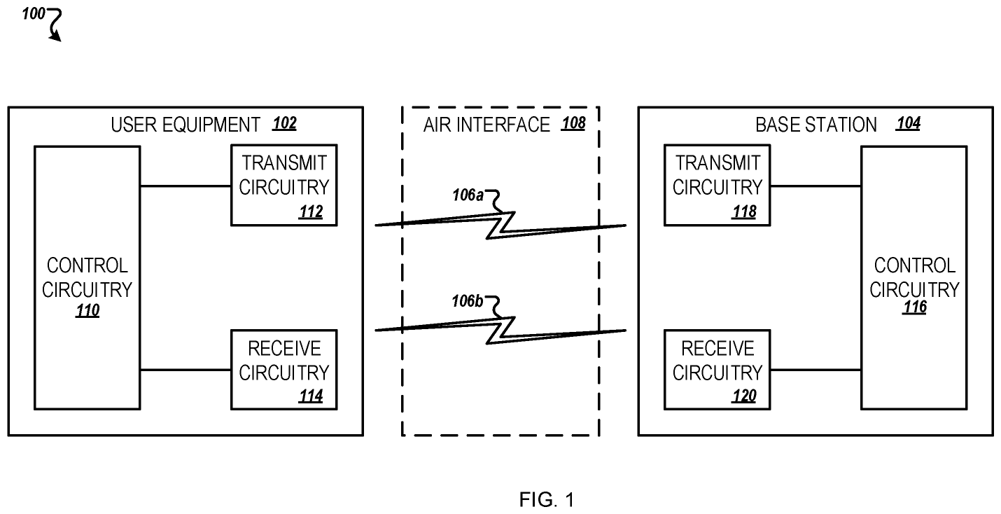

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can be adapted or configured to dynamically adjust the number and/or type of RATs used to establish wireless links between the UE 102 and the base station 104 (e.g., using the transmit circuitry 112 and/or the receive circuitry 114).

The transmit circuitry 112 can perform various operations described in this specification. For example, the transmit circuitry 112 can be adapted or configured to dynamically establish and/or terminate one or more wireless links between the user equipment 102 and the base station 104 (e.g., using one or more RATs, in accordance with commands provided by the control circuitry 110). Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can be adapted or configured to dynamically establish and/or terminate one or more wireless links between the user equipment 102 and the base station 104 104 (e.g., using one or more RATs, in accordance with commands provided by the control circuitry 110). Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

As described above, to improve the performance of a UE device, the UE device can dynamically adjust the number and/or type of RATs that are used to establish wireless links with base stations. For instance, the UE device can use multiple RATs concurrently to establish multiple respective wireless links with one or more base stations, and dynamically prune a RAT and terminate its corresponding wireless link, upon determining that doing so would improve the network performance of the UE device. Likewise, the UE device can re-establish a previously terminated wireless links using a previously pruned RAT upon determining that doing so would improve the network performance of the UE device.

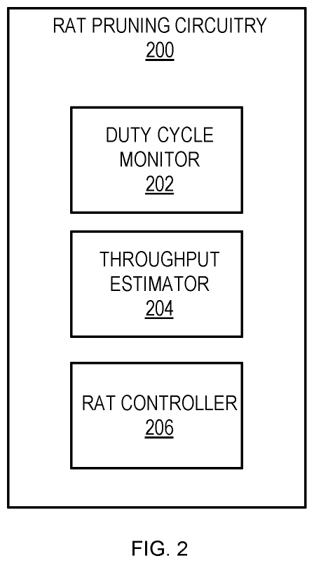

FIG. 2 shows example RAT pruning circuitry 200 for performing at least some of the operations described herein. The RAT pruning circuitry 200 includes a duty cycle monitor 202, a throughput estimator 204, and a RAT controller 206. In some implementations, the RAT pruning circuitry 200 can be implemented, at least in part, in a UE device (e.g., the UE 102 shown in FIG. 1). In some implementations, the RAT pruning circuitry 200 can be implemented, at least in part, in control circuitry, transmit circuitry, and/or receive circuitry of a UE device (e.g., control circuitry 110, transmit circuitry 112, and/or receive circuitry 114 shown in FIG. 1).

In general, the RAT controller 206 is adapted or configured to control the establishment and/or termination of wireless links between electronic devices using one or more RATs. As an example, if the RAT pruning circuitry 200 is implemented in a UE device, the RAT controller 206 can be configured to dynamically establish one or more wireless links between the UE device and another electronic device (e.g., a base station), and to dynamically terminate one or more of the established wireless links.

Further, the RAT controller 206 can specify which particular RAT is used to establish each respective wireless link, and which RAT should be terminated or pruned. For example, the RAT controller 206 can specify that two wireless link be established using two respective RATs. Further, the RAT can specify that one of the RATs (and its corresponding wireless link) be terminated or pruned. Further, the RAT can specify that the pruned RAT (and its corresponding wireless link) be re-established.

In general, the duty cycle monitor 202 is adapted or configured to determine the proportion of time that a device of the RAT pruning circuitry 200 (e.g., a UE device) is performing certain network operations. As an example, the duty cycle monitor 202 can be is adapted or configured to determine the proportion of time that the UE device is uploading data (e.g., transmitting data to another device, such as a base station). As another example, the duty cycle monitor can be is adapted or configured to determine the proportion of time that the UE device is downloading data (e.g., receiving data to another device, such as a base station).

In general, the throughput estimator 204 is adapted or configured to estimate the network performance of a device of the RAT pruning circuitry 200 (e.g., a UE device) based on various conditions or configurations of the device. As an example, the throughput estimator 204 can be configured to estimate the data throughput between a UE device and a base station using a current network configuration of the UE device (e.g., using the currently configuration of RATs). As another example, the throughput estimator 204 can be configured to estimate the data throughput between the UE device and the base station if the UE device were to establish one or more additional wireless links with the base station (e.g., concurrently with previously established wireless link(s)) using one or more additional RATs. As another example, the throughput estimator 204 can be configured to estimate the data throughput between the UE device and the base station if the UE device were to terminate (or “prune”) one or more RATs and their corresponding wireless links.

In some implementations, the RAT controller 206 controls the establishment and/or termination of wireless links based on data provided by the duty cycle monitor 202 and the throughput estimator 204.

As an example, the RAT controller 206 can receive data from the duty cycle monitor 202 and the throughput estimator 204, and determine that the data satisfies a particular set of criteria. In response, the RAT controller can cause multiple wireless links to be established using multiple RATs concurrently (e.g., between a UE device and a base station). These criteria can represent, for example, circumstances in which it would be advantageous to transmit and/or receive data via multiple wireless links and multiple RATs concurrently (e.g., to transfer data quickly, reliability, etc. using multiple wireless link concurrently).

As another example, the RAT controller 206 can receive data from the duty cycle monitor 202 and the throughput estimator 204, and determine that the data satisfies another set of criteria. In response, the RAT controller can cause one or more of the RATs (and its corresponding wireless links) to be terminated or pruned. These criteria can represent, for example, circumstances in which it would be advantageous to transmit and/or receive data via fewer wireless links and RATs (e.g., a single wireless link using a single RAT at a time).

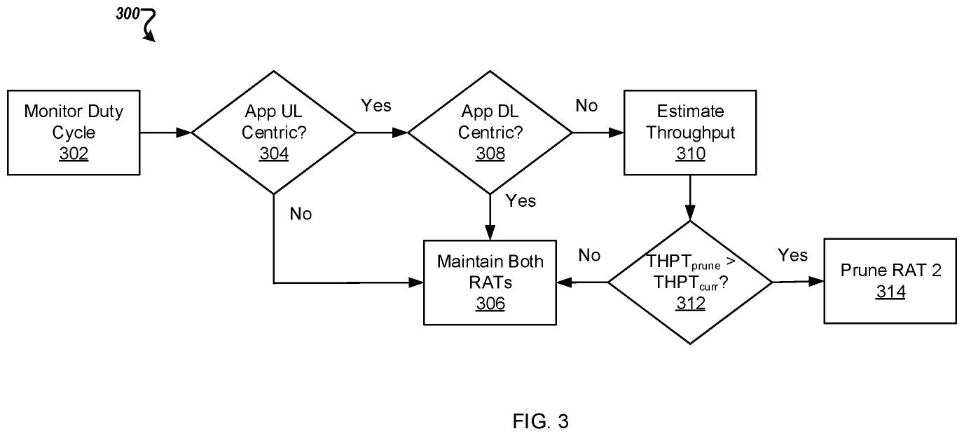

An example process 300 for dynamically pruning RATs is shown in FIG. 3. In particular, the process 300 can be performed by a UE device to determine whether to concurrently use two RATs to maintain two concurrent wireless links with one or more base stations, or to selectively prune one of the RATs (and terminate its corresponding wireless link) such that only a single RAT and a single wireless link is maintained. For example, the process 300 can be performed by a UE device to determine whether to (i) concurrently maintain a first wireless link (established using a first RAT) and a second wireless link (established using a second RAT), or (ii) selectively prune the second RAT and terminate the second wireless link, such that only the first wireless link is maintained using the first RAT. The process 300 can be performed, for example, using the RAT pruning circuitry 200 of a UE device.

In the process 300, the RAT pruning circuitry 200 monitors the proportion of time that a UE device is performing certain network operations (block 302). As an example, as described above, the RAT pruning circuitry 200 can receive data from the duty cycle monitor 202 indicating the proportion of time that the UE device is uploading data to a base station (e.g., an “uplink duty cycle”). As another example, the RAT pruning circuitry 200 can receive data from the duty cycle monitor 202 indicating the proportion of time that the UE device is downloading data (e.g., a “downlink duty cycle”).

In some implementations, the uplink duty cycle can be calculated according to the following relationship:

$$d {c}_{T , UL} = Active {Time}_{UL} / Total Time ,$$

where dc_{T,UL} is the uplink duty cycle, ActiveTime_{UL} is the amount of time (or number of time slots) with uplink transmissions from the UE device to the base station in a time window TotalTime. In some implementations, the uplink duty cycle can be calculated periodically (e.g., over a sliding time window TotalTime).

Similarly, the uplink duty cycle can be calculated according to the following relationship:

$$d {c}_{T , DL} = Active {Time}_{DL} / Total Time ,$$

where dc_{T,DL} is the downlink duty cycle, ActiveTime_{DL} is the amount of time (or number of time slots) with downlink transmissions from the base station to the UE device in a time window TotalTime. In some implementations, the downlink duty cycle can be calculated periodically (e.g., over a sliding time window TotalTime).

In some implementations, a weighted duty cycle can be determined based on historical activity of the UE device. For example, a weighted uplink duty cycle can be calculated according to the following relationship:

$$D {C}_{T , UL} = ( 1 - α ) * D {C}_{T - 1 , UL} + α * d {c}_{T , UL} ,$$

where DC_{T,UL} is the weighted uplink duty cycle (e.g., at a time T), dc_{T,UL} is the uplink duty cycle, DC_{T-1,UL} is a previously determined weighted uplink duty cycle (e.g., at a time T−1), and a is a weighting coefficient. The weighting coefficient α is a tunable value and can be set based on empirical studies. As an example, in some implementations, the weighting coefficient α can be ⅛. In practice, higher or lower weighting coefficients can be used to differently weight historical activity.

Similarly, a weighted downlink duty cycle can be calculated according to the following relationship:

$$D {C}_{T , DL} = ( 1 - α ) * D {C}_{T - 1 , DL} + α * d {c}_{T , DL} ,$$

where DC_{T,DL} is the weighted downlink duty cycle (e.g., at a time T), dc_{T,DL} is the downlink duty cycle, DC_{T-1,DL} is a previously determined weighted downlink duty cycle (e.g., at a time T−1), and a is a weighting coefficient. As described above, the weighting coefficient α is a tunable value and can be set based on empirical studies. As an example, in some implementations, the weighting coefficient α can be ⅛. In practice, higher or lower weighting coefficients can be used to differently weight historical activity.

Further, according to the process 300, the RAT pruning circuitry 200 determines whether the UE device is running any applications that may be considered “uplink centric” (block 304). Uplink centric applications may refer to applications that are uploading data (e.g., from the UE to the base station) at a particular high frequency or rate.

In some implementations, the RAT pruning circuitry 200 can determine whether the UE device is running any uplink centric applications by comparing the weighted uplink duty cycle DC_{T,UL} to a threshold value Threshold_{UL}. For example, if DC_{T,UL}>Threshold_{UL}, the RAT pruning circuitry 200 can determine that the UE device is running an uplink centric application. As another example, if DC_{T,UL}≤Threshold_{UL}, the RAT pruning circuitry 200 can determine that the UE device is not running an uplink centric application. The threshold value Threshold_{UL} is a tunable value and can be set based on empirical studies.

If the RAT pruning circuitry 200 determines that the UE device is not running any uplink centric applications, the RAT pruning circuitry 200 causes the two wireless links to be maintained between the UE and the base station using two respective RATs (block 306). For example, the RAT pruning circuitry 200 can refrain from pruning either of the RATs (and refrain from terminating their corresponding wireless links between the UE device and the base station). As another example, the RAT pruning circuitry 200 can use the RAT controller 206 to instruct the transmit circuitry 112 and/or the receive circuitry 114 to maintain both of the RATs (and maintain their corresponding wireless links between the UE device and the base station).

Alternatively, if the RAT pruning circuitry 200 determines that the UE device is running an uplink centric application, the RAT pruning circuitry 200 determines whether the UE device is running any applications that may be considered “downlink centric” (block 308). Downlink centric applications may refer to applications that are downloading data (e.g., from the base station to the UE) at a particular high frequency or rate.

In some implementations, the RAT pruning circuitry 200 can determine whether the UE device is running any downlink centric applications by comparing the weighted downlink duty cycle DC_{T,DL} to a threshold value Threshold_{DL}. For example, if DC_{T,DL}>Threshold_{DL}, the RAT pruning circuitry 200 can determine that the UE device is running a downlink centric application. As another example, if DC_{T,DL}≤Threshold_{DL}, the RAT pruning circuitry 200 can determine that the UE device is not running a downlink centric application. The threshold value Threshold_{DL} is a tunable value and can be set based on empirical studies.

If the RAT pruning circuitry 200 determines that the UE device is running a downlink centric application, the RAT pruning circuitry 200 causes the two wireless links to be maintained between the UE and the base station using two respective RATs (block 306). For example, the RAT pruning circuitry 200 can refrain from pruning either of the RATs (and refrain from terminating their corresponding wireless links between the UE device and the base station). As another example, the RAT pruning circuitry 200 can use the RAT controller 206 to instruct the transmit circuitry 112 and/or the receive circuitry 114 to maintain both of the RATs (and maintain their corresponding wireless links between the UE device and the base station).

Alternatively, if the RAT pruning circuitry 200 determines that the UE device is not running a downlink centric application, the RAT pruning circuitry 200 estimates the throughput of the UE device (block 310). In particular, the RAT pruning circuitry 200 determines the throughput of the UE device to the base station based on the current network configuration of the UE device (e.g., in which two wireless links are maintained using two RATs concurrently), referred to as THTP_{current}. Further, the RAT pruning circuitry 200 determines the throughput of the UE device to the base station if one of the RATs were to be pruned and its corresponding wireless link were to be terminated, referred to as THT Pₚᵣᵤₙₑ.

As described above, the RAT pruning circuitry 200 can receive estimates of the throughput of the UE device from the throughput estimator 204. In some implementations, the throughput estimator 204 can estimate the throughput of the UE device based on properties or characteristics of the wireless links(s) between the UE device and the base station. For example, the throughput estimator 204 can obtain data representing the signal-strength of the wireless link(s), such as the Reference Signal Received Power (RSRP), Reference Signal Received Quality (RSRQ), Signal-to-Noise Ratio (SNR), Signal-to-Interference-Plus-Noise Ratio (SINR), or any other metric presenting the signal-strength of the wireless link(s). Further, the throughput estimator can obtain data representing the radio configuration parameters of the UE device, such as the channel bandwidth (BW), modulation coding scheme (MSC), etc.

Based on this data, the throughput estimator 204 can estimate the throughput of the UE (e.g., both THTP_{current} and THTPₚᵣᵤₙₑ). For instance, in some implementation, the throughput estimator 204 can estimate the throughput of the UE using a look up table or chart (e.g., a pre-defined table or chart) showing a particular estimated bandwidth, given a particular signal-strength and radio configuration of the UE device.

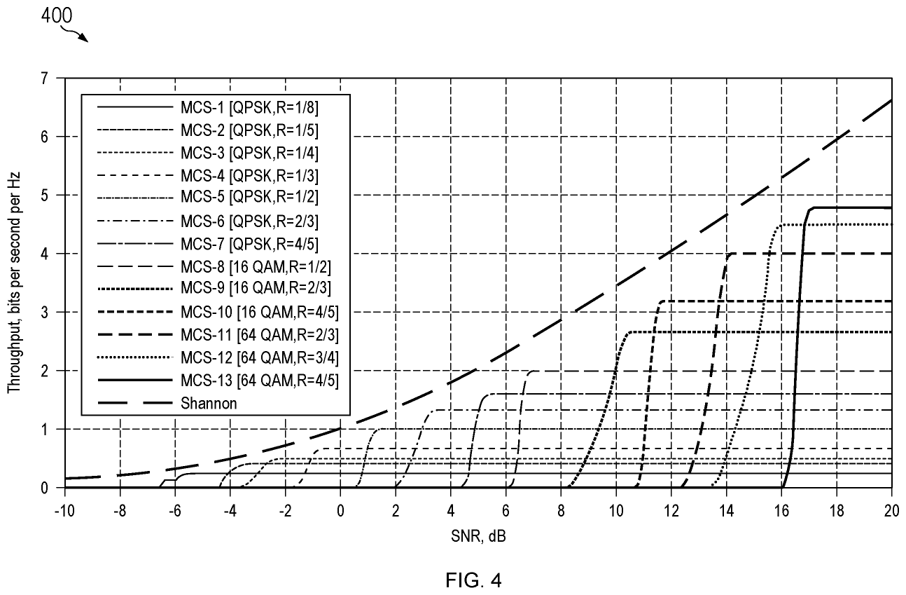

An example chart 400 is shown in FIG. 4, adapted from 3rd Generation Partnership Project (3GPP) Technical Report 36.942 V 10.3.0. The chart 400 indicates, for a given radio configuration (a particular plotted line) and a given signal strength (horizontal axis), a corresponding estimated throughput (vertical axis). In the chart 400, an estimated throughput is indicated in bits per second per Hz of bandwidth. The total effective throughput can be determined by multiplying this figure by the bandwidth of the wireless link.

In some implementation, the throughput estimator 204 can estimate the throughput of the UE devices using crowd sourced measurements or observations. For example, a monitoring system can collect data regarding the network performance (e.g., throughput) of multiple UE devices under various conditions (e.g., locations, signal-strengths of wireless links, radio configurations, RATs, telecommunications carriers or providers, device types, etc.). Further, the monitoring system can determine correlations or trends between the conditions of the UE devices and their network performance. Based on these correlations or trends, the monitoring system can estimate the network performance of a UE device given a particular set of conditions of the UE device (e.g., by interpolating or extrapolating an estimated network performance from the correlations or trends, given the set of conditions of the UE device). In some implementations, the monitoring system can be implemented as a part of the throughput estimator 204 and/or the RAT pruning circuitry 200. In some implementations, the monitoring system can be implemented remotely from the throughput estimator 204 and/or the RAT pruning circuitry 200 (e.g., on a remote server or cloud computing platform), and can provide the throughput estimator 204 and/or the RAT pruning circuitry 200 with data regarding estimated throughputs via a wired or wireless link.

In some implementations, the throughput THTP_{curr} can be estimated by measuring the signal-strength of the currently established wireless links (e.g., using the currently active RATs), and determining the throughput THTP_{curr} corresponding to the measured signal-strength (e.g., using a look up table or chart and/or a monitoring system, as described above).

Further, the throughput THT Pₚᵣᵤₙₑ can be estimated by measuring the signal-strength of the currently established wireless links, and estimating the signal-strength if one of the RATs and its corresponding wireless link were to be terminated or pruned.” In turn, this estimated signal-strength can be used to determine the throughput THT Pₚᵣᵤₙₑ (e.g., using a look up table or chart and/or a monitoring system, as described above).

As an example, the throughput THTP_{curr} can be estimated by measuring the SNR of the currently established wireless links (SNR_{curr}), and determining the throughput THTP_{current} corresponding to the measured signal-strength SNR_{curr} (e.g., using a look up table or chart and/or a monitoring system, as described above).

Further, the throughput THT P_{curr} can be estimated by estimating the signal-strength if one of the wireless links were to be terminated (or “pruned”) (SNRₚᵣᵤₙₑ), according to be following relationship:

$$S N {R}_{prune} = S N {R}_{curr} + 10 * \frac{P / {N}_{ant , prune}}{P / {N}_{ant , curr}} ,$$

where P is the transmit power and N_{ant,curr} is the number of antennas used in the current network configuration (e.g., using two RATs concurrently), and N_{ant,prune} is the number of antennas that would be used in a network configuration in which one of the RATs and wireless links were to be terminated or pruned.

For instance, for an example UE device, N_{ant,curr}=2 and N_{ant,prune}=1 Accordingly, for this example UE device, SNRₚᵣᵤₙₑ=SNR_{curr}+3 dB. In practice, a UE device can have configurations other than those described above.

Referring back to FIG. 3, the RAT pruning circuitry 200 compares the throughput THT Pₚᵣᵤₙₑ and the throughput THTP_{curr} (block 312).

If the RAT pruning circuitry 200 determines that THTPₚᵣᵤₙₑ≤THTP_{curr}, this indicates that the network performance of the UE device may be higher by maintaining both RATs and their corresponding wireless links, rather than only a single RAT and single wireless link. Based on this determination, the RAT pruning circuitry 200 causes the two wireless links to be maintained between the UE and the base station using two respective RATs (block 306). For example, the RAT pruning circuitry 200 can refrain from pruning either of the RATs (and refrain from terminating their corresponding wireless links between the UE device and the base station). As another example, the RAT pruning circuitry 200 can use the RAT controller 206 to instruct the transmit circuitry 112 and/or the receive circuitry 114 to maintain both of the RATs (and maintain their corresponding wireless links between the UE device and the base station).

Alternatively, if the RAT pruning circuitry 200 determines that THT Pₚᵣᵤₙₑ>THTP_{curr}, this indicates that the network performance of the UE device may be higher by selectively pruning one of the RATs and terminating its corresponding wireless link, rather than maintaining both RATs and wireless links. Based on this determination, the RAT pruning circuitry 200 selectively causes one of the RATs to be terminated or pruned (block 314). For example, the RAT pruning circuitry 200 can use the RAT controller 206 to instruct the transmit circuitry 112 and/or the receive circuitry 114 to maintain the first wireless link between the UE device and the base station using the first RAT, and to terminate the second wireless link between the UE device and the base station using the second RAT.

In general, a UE device can perform the process 300 to determine whether to maintain two wireless links using two RATs concurrently, or to selectively prune of the RATs and terminate its corresponding wireless link. As an example, a UE device can establish a first wireless link using a first RAT and a second wireless link with a second RAT. If a particular set of criteria is satisfied (e.g., the UE device is running an uplink centric application, is not running a downlink centric application, and THTPₚᵣᵤₙₑ>THTP_{curr}), the UE device can selectively prune the second RAT, terminate the second wireless link, and maintain the first wireless link using the first RAT. Otherwise, if the set of criteria is not satisfied (e.g., the UE device is not running an uplink centric application, is running a downlink centric application, and/or THT Pₚᵣᵤₙₑ≤THTP_{curr}), the UE device can maintain both the first and second wireless link using the first and second RATs, respectively.

As discussed above, in some implementations, the first wireless link and second link wireless link can be established using different respective RATs. Further, in some implementations, RATs can enable UE devices to establish “standalone” (SA) wireless links with one or more base stations (e.g., wireless links that can be operated independent of other wireless links) and/or “non-standalone” (NSA) wireless links with one or more base stations (e.g., wireless links that are operated in conjunction with other wireless links). For instance, a first RAT can enable a UE device to establish a first SA wireless link, and a second RAT can enable the UE device to establish a second NSA wireless link. The first SA wireless link can be operated either independent from or in conjunction with the second NSA wireless link, whereas the second NSA wireless link is operated solely in conjunction with the first SA wireless link.

As an example, according to 5G E-UTRAN New Radio-Dual Connectivity (5G ENDC), a UE device can access a wireless network using 4G (e.g., LTE) and 5G wireless links concurrently. In this example, the first SA wireless link can be a LTE wireless link, and the second NSA wireless link can be a 5G NSA FR1 wireless link (which is operated solely in conjunction with the LTE wireless link). A UE device can perform the process 300 to determine whether to maintain the LTE wireless link and the 5G NSA FR1 wireless link concurrently, or to selectively terminate the 5G NSA FR1 wireless link and maintain the LTE wireless link only.

Although example types of wireless links and RATs are described above, in practice, the system and techniques described herein can be used to adjust the operation of other types of wireless links and RATs (e.g., in addition to or instead of those described above).

Further, the RAT pruning circuitry 200 can continue monitoring the network performance of the UE device to determine whether to re-add a previously pruned RAT and re-establish its corresponding wireless link. As an example, subsequent to pruning a RAT, the RAT pruning circuitry 200 can determine the throughput of the UE device to the base station based on the current network configuration of the UE device (e.g., in which a single wireless link is maintained using a single RAT), referred to as THTP_{current}. Further, the RAT pruning circuitry 200 determines the throughput of the UE device to the base station if the previously pruned RAT were to be re-added or re-activated its corresponding wireless link were to be re-established, referred to as THT P_{after_rat_addition}. If the RAT pruning circuitry 200 determines that THTP_{after_rat_addition}>THT P_{curr}, this indicates that the network performance of the UE device may be higher by selectively re-adding or re-reactive the previously pruned RAT and re-establishing its corresponding, rather than using a single RAT and single wireless link only. Based on this determination, the RAT pruning circuitry 200 selectively causes the previously pruned RAT to be re-added or re-activated and its corresponding wireless link to be re-established. Otherwise, the RAT pruning circuitry 200 maintains use of a single RAT and a single corresponding wireless link.

In the example process 300 shown in FIG. 3, the RAT pruning circuitry 200 determines whether to prune a RAT, in part, by comparing the throughput THT Pₚᵣᵤₙₑ and the throughput THTP_{curr} (block 312). However, in some implementations, the RAT pruning circuitry 200 can determine whether to prune a RAT, in part, by comparing the throughput THTPₚᵣᵤₙₑ and the throughput THT P_{curr} plus a constant value C.

As an example, if the RAT pruning circuitry 200 determines that THTPₚᵣᵤₙₑ>THT P_{curr}+C₁, this indicates that the network performance of the UE device may be higher by a sufficiently large degree (e.g., a throughput increase of at least C₁) by selectively pruning one of the RATs and terminating its corresponding wireless link, rather than maintaining both RATs and wireless links. Based on this determination, the RAT pruning circuitry 200 selectively causes one of the RATs to be terminated or pruned (block 314). Otherwise, the RAT pruning circuitry 200 causes the two wireless links to be maintained between the UE and the base station using two respective RATs (block 306).

Similarly, a constant value can be used to determine whether to re-add or re-activate a previously pruned RAT. For example, if the RAT pruning circuitry 200 determines that THTP_{after_rat_addition}>THTP_{curr}+C₂, this indicates that the network performance of the UE device may be higher by a sufficiently large degree (e.g., a throughput increase of at least C₂) by selectively re-adding or re-activating the previously pruned RAT and re-establishing its corresponding wireless link, rather than using a single RAT and single wireless link only. Based on this determination, the RAT pruning circuitry 200 selectively causes the previously pruned RAT to be re-added or re-activated and its corresponding wireless link to be re-established. Otherwise, the RAT pruning circuitry 200 maintains use of a single RAT and a single corresponding wireless link.

Use of the constant values C₁ and C₂ can be beneficial, for example, in reducing the frequency by which RATs are pruned and/or subsequently re-added or re-activated (which may degrade performance of the UE and/or the wireless network). In practice, the constant values C₁ and C₂ are tunable values and can be set based on empirical studies. In some implementations, at least one of C₁ and C₂ can be zero. In some implementations, at least one of C₁ and C₂ can be greater than zero.

In some implementations, after the RAT pruning circuitry 200 has pruned a RAT, the RAT pruning circuitry 200 can refrain from re-adding or re-activating the RAT for a time interval t₁. Further, after the RAT pruning circuitry 200 has re-added or re-activated a RAT, the RAT pruning circuitry 200 can refrain from pruned the RAT for a time interval t₂. Restricting pruning and re-activating in this manner can be beneficial, for example, in reducing the frequency by which RATs are pruned and/or subsequently re-added or re-activated (which may degrade performance of the UE and/or the wireless network). In practice, the time intervals t₁ and t₂ are tunable values and can be set based on empirical studies. In some implementations, at least one of t₁ and t₂ can be zero. In some implementations, at least one of t₁ and t₂ can be greater than zero.

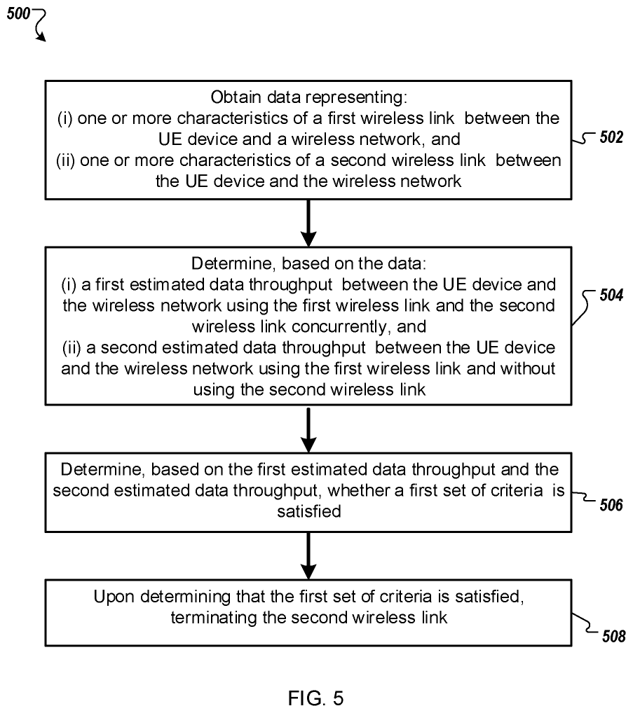

FIG. 5 illustrates a flowchart of an example method 500, according to some implementations. For clarity of presentation, the description that follows generally describes method 500 in the context of the other figures in this description. For example, method 500 can be performed by the UE 102 (e.g., as shown in FIG. 1) and/or the RAT pruning circuitry 200 (e.g., as shown in FIG. 2). It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

In the method 500, a UE device obtains data representing (i) one or more characteristics of a first wireless link between the UE device and a wireless network, and (ii) one or more characteristics of a second wireless link between the UE device and the wireless network (block 502).

In some implementations, the one or more characteristics of the first wireless link can include a signal strength of the first wireless link. Further, the one or more characteristics of the second wireless link can include a signal strength of the second wireless link.

Further, the UE device determines, based on the data: (i) a first estimated data throughput between the UE device and the wireless network using the first wireless link and the second wireless link concurrently, and (ii) a second estimated data throughput between the UE device and the wireless network using the first wireless link and without using the second wireless link (block 504).

In some implementations, the first estimated data throughput and the second estimated data throughput can be determined based on the signal strength of the first wireless link and the signal strength of the second wireless link.

In some implementations, the first estimated data throughput and the second estimated data throughput can be determined based on historical data obtained from one or more additional UE devices.

Further, the UE device determines, based on the first estimated data throughput and the second estimated data throughput, whether a first set of criteria is satisfied (block 506).

In some implementations, the first set of criteria can include a criterion that the second estimated data throughput is greater than a sum of the first estimated data throughput and a constant value. In some implementations, the constant value can be zero. In some implementations, the constant value can be greater than zero.

In some implementations, the first set of criteria can include a criterion that a first metric representing an upload activity of the UE device is greater than a first threshold value. In some implementations, the first metric can be calculated based on an uplink duty cycle of the UE device.

In some implementations, the first set of criteria can include a criterion that a second metric representing a download activity of the UE device is less than a second threshold value. In some implementations, the second metric can be calculated based on a downlink duty cycle of the UE device.

Further, upon determining that the first set of criteria is satisfied, the UE device terminates the second wireless link (block 508).

In some implementations, the first wireless link can be established using a first radio access technology (RAT), and the second wireless link is established using a second RAT different from the first RAT.

In some implementations, the first RAT can be a stand-alone RAT, and the second RAT can be a non-stand-alone RAT.

In some implementations, the first RAT can be a Fourth Generation (4G) RAT, and the second RAT can be a Fifth Generation Non-Stand-Alone (5G-NSA) RAT.

In some implementations, subsequent to terminating the second wireless link the UE device can re-determining, based on the data: (i) the first estimated data throughput, and (ii) the second estimated data throughput. Further, the UE device can determine, based on first estimated data throughput and the second estimated data throughput, whether a second set of criteria is satisfied. Further, upon determining that the second set of criteria is satisfied, the UE device can re-establish the second wireless link.

In some implementations, the second set of criteria can include a criterion that the first estimated data throughput is greater than a sum of the second estimated data throughput and the constant value.

In some implementations, the second set of criteria can include a criterion that a time at which the second wireless link was terminated is earlier than a threshold time.

The example method 500 shown in FIG. 5 can be modified or reconfigured to include additional, fewer, or different steps (not shown in FIG. 5), which can be performed in the order shown or in a different order.

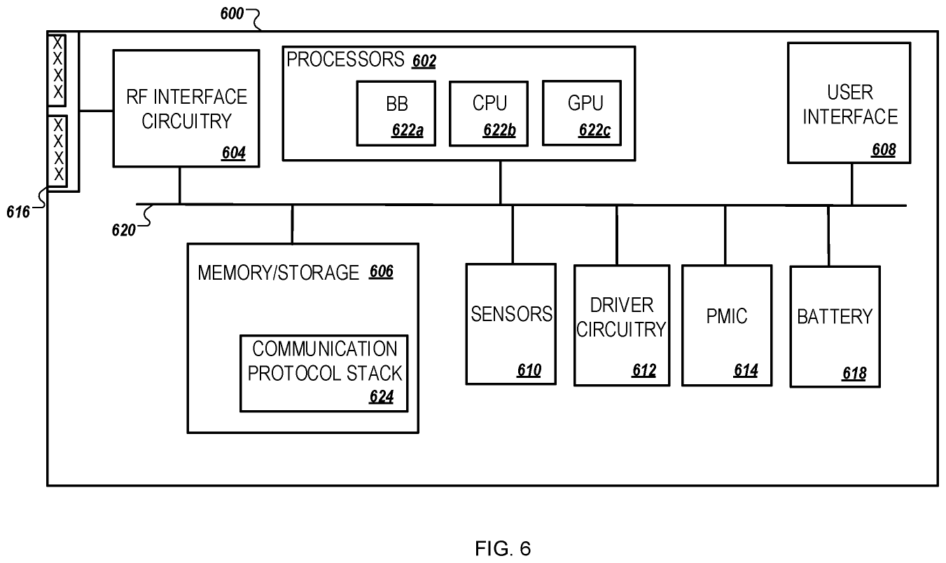

FIG. 6 illustrates a UE 600, according to some implementations. The UE 600 may be similar to and substantially interchangeable with UE 102 of FIG. 1.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616. In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

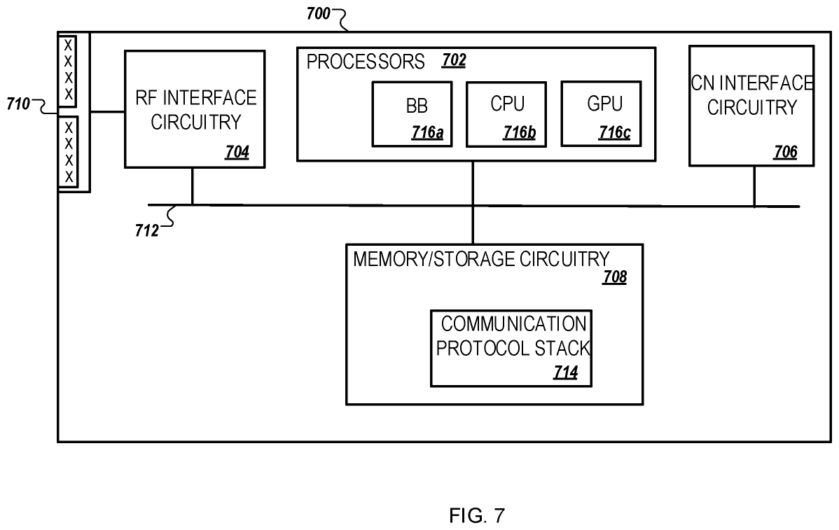

FIG. 7 illustrates an access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### EXAMPLE ITEMS

Example 1 is a method that is performed by a user equipment (UE) device. The method includes obtaining data representing: one or more characteristics of a first wireless link between the UE device and a wireless network, and one or more characteristics of a second wireless link between the UE device and the wireless network; determining, based on the data: a first estimated data throughput between the UE device and the wireless network using the first wireless link and the second wireless link concurrently, and a second estimated data throughput between the UE device and the wireless network using the first wireless link and without using the second wireless link; determining, based on the first estimated data throughput and the second estimated data throughput, whether a first set of criteria is satisfied; and upon determining that the first set of criteria is satisfied, terminating the second wireless link.

Example 2 is a method that includes the method of Example 1, where the one or more characteristics of the first wireless link includes a signal strength of the first wireless link, and where the one or more characteristics of the second wireless link includes a signal strength of the second wireless link.

Example 3 is a method that includes the method of Example 2, where the first estimated data throughput and the second estimated data throughput are determined based on the signal strength of the first wireless link and the signal strength of the second wireless link.

Example 4 is a method that includes the method of Example 1, where the first estimated data throughput and the second estimated data throughput are determined based on historical data obtained from one or more additional UE devices.

Example 5 is a method that includes the method of Example 1, where the first set of criteria includes a criterion that the second estimated data throughput is greater than a sum of the first estimated data throughput and a constant value.

Example 6 is a method that includes the method of Example 5, where the constant value is zero.

Example 7 is a method that includes the method of Example 5, where the constant value is greater than zero.

Example 8 is a method that includes the method of Example 5, where the first set of criteria further includes a criterion that a first metric representing an upload activity of the UE device is greater than a first threshold value.

Example 9 is a method that includes the method of Example 8, where the first metric is calculated based on an uplink duty cycle of the UE device.

Example 10 is a method that includes the method of Example 9, where the first set of criteria further includes a criterion that a second metric representing a download activity of the UE device is less than a second threshold value.

Example 11 is a method that includes the method of Example 9, where the second metric is calculated based on a downlink duty cycle of the UE device.

Example 12 is a method that includes the method of Example 1, where the first wireless link is established using a first radio access technology (RAT), and the second wireless link is established using a second RAT different from the first RAT.

Example 13 is a method that includes the method of Example 12, where the first RAT is a stand-alone RAT, and where the second RAT is a non-stand-alone RAT.

Example 14 is a method that includes the method of Example 13, where the first RAT is a Fourth Generation (4G) RAT, and where the second RAT is a Fifth Generation Non-Stand-Alone (5G-NSA) RAT.

Example 15 is a method that includes the method of Example 1, and further including, subsequent to terminating the second wireless link: re-determining, based on the data: the first estimated data throughput, and the second estimated data throughput; determining, based on first estimated data throughput and the second estimated data throughput, whether a second set of criteria is satisfied; and upon determining that the second set of criteria is satisfied, re-establishing the second wireless link.

Example 16 is a method that includes the method of Example 15, where the second set of criteria includes a criterion that the first estimated data throughput is greater than a sum of the second estimated data throughput and the constant value.

Example 17 is a method that includes the method of Example 16, where the second set of criteria includes a criterion that a time at which the second wireless link was terminated is earlier than a threshold time.

Example 18 is an apparatus including one or more baseband processors configured to perform the method of any of Examples 1 to 17.

Example 19 is a system including one or processors and one or more storage devices on which are stored instructions that are operable, when executed by the one or more processors, to cause the one or more processors to perform the method of any of Examples 1 to 17.

Example 20 is a non-transitory computer storage medium encoded with instructions that, when executed by one or more processors, cause the one or more processors to perform the method of any of Examples 1 to 17.

1. A method comprising:
obtaining data representing:
one or more characteristics of a first wireless link between a user equipment (UE) device and a wireless network, and
one or more characteristics of a second wireless link between the UE device and the wireless network;
determining, based on the data:
a first estimated data throughput between the UE device and the wireless network using the first wireless link and the second wireless link concurrently, and
a second estimated data throughput between the UE device and the wireless network using the first wireless link and without using the second wireless link;
determining, based on the first estimated data throughput and the second estimated data throughput, whether a first set of criteria is satisfied; and
upon determining that the first set of criteria is satisfied, terminating the second wireless link.

2. The method of claim 1, wherein the one or more characteristics of the first wireless link comprises a signal strength of the first wireless link, and
wherein the one or more characteristics of the second wireless link comprises a signal strength of the second wireless link.

3. The method of claim 2, wherein the first estimated data throughput and the second estimated data throughput are determined based on the signal strength of the first wireless link and the signal strength of the second wireless link.

4. The method of claim 1, wherein the first estimated data throughput and the second estimated data throughput are determined based on historical data obtained from one or more additional UE devices.

5. The method of claim 1, wherein the first set of criteria comprises:
a criterion that the second estimated data throughput is greater than a sum of the first estimated data throughput and a constant value.

6. The method of claim 5, wherein the constant value is zero.

7. The method of claim 5, wherein the constant value is greater than zero.

8. The method of claim 5, wherein the first set of criteria further comprises:
a criterion that a first metric representing an upload activity of the UE device is greater than a first threshold value.

9. The method of claim 8, wherein the first metric is calculated based on an uplink duty cycle of the UE device.

10. The method of claim 9, wherein the first set of criteria further comprises:
a criterion that a second metric representing a download activity of the UE device is less than a second threshold value.

11. The method of claim 9, wherein the second metric is calculated based on a downlink duty cycle of the UE device.

12. The method of claim 1, wherein the first wireless link is established using a first radio access technology (RAT), and the second wireless link is established using a second RAT different from the first RAT.

13. The method of claim 12, wherein the first RAT is a stand-alone RAT, and wherein the second RAT is a non-stand-alone RAT.

14. The method of claim 13, wherein the first RAT is a Fourth Generation (4G) RAT, and wherein the second RAT is a Fifth Generation Non-Stand-Alone (5G-NSA) RAT.

15. The method of claim 1, further comprising, subsequent to terminating the second wireless link:
re-determining, based on the data:
the first estimated data throughput, and
the second estimated data throughput;
determining, based on first estimated data throughput and the second estimated data throughput, whether a second set of criteria is satisfied; and
upon determining that the second set of criteria is satisfied, re-establishing the second wireless link.

16. The method of claim 15, wherein the second set of criteria comprises:
a criterion that the first estimated data throughput is greater than a sum of the second estimated data throughput and the constant value.

17. The method of claim 16, wherein the second set of criteria comprises:
a criterion that a time at which the second wireless link was terminated is earlier than a threshold time.

18. An apparatus comprising one or more baseband processors configured to perform operations comprising:
obtaining data representing:
one or more characteristics of a first wireless link between a user equipment (UE) device and a wireless network, and
one or more characteristics of a second wireless link between the UE device and the wireless network;
determining, based on the data:
a first estimated data throughput between the UE device and the wireless network using the first wireless link and the second wireless link concurrently, and
a second estimated data throughput between the UE device and the wireless network using the first wireless link and without using the second wireless link;
determining, based on the first estimated data throughput and the second estimated data throughput, whether a first set of criteria is satisfied; and
upon determining that the first set of criteria is satisfied, terminating the second wireless link.

19. A system comprising one or processors and one or more storage devices on which are stored instructions that are operable, when executed by the one or more processors, to cause the one or more processors to perform operations comprising:
obtaining data representing:
one or more characteristics of a first wireless link between a user equipment (UE) device and a wireless network, and
one or more characteristics of a second wireless link between the UE device and the wireless network;
determining, based on the data:
a first estimated data throughput between the UE device and the wireless network using the first wireless link and the second wireless link concurrently, and
a second estimated data throughput between the UE device and the wireless network using the first wireless link and without using the second wireless link;
determining, based on the first estimated data throughput and the second estimated data throughput, whether a first set of criteria is satisfied; and
upon determining that the first set of criteria is satisfied, terminating the second wireless link.

20. (canceled)
